(19) United States
(12) Patent Application Publication
(10) Pub. No.: US 2012/0310841 A1
(43) Pub. Date: Dec. 6, 2012

(54) METHOD OF REPRESENTING STATUS OF A LEGISLATIVE ISSUE AND A LEGISLATIVE TRACKER FOR TRACKING LEGISLATIVE ISSUES

(76) Inventor: Brinton Payne, Fort Worth, TX (US)

(21) Appl. No.: 13/474,554

(22) Filed: May 17, 2012

Related U.S. Application Data
(60) Provisional application No. 61/491,382, filed on May 31, 2011.

(51) Int. Cl. G06Q 10/06

(52) U.S. Cl. 705/301

(57) ABSTRACT

A legislative tracker, a method of representing status of a legislative matter and an apparatus are disclosed herein. In one embodiment, the apparatus includes: (1) a data interface configured to receive legislative data associated with a legislative issue and (2) a computer processor configured to generate a progress marker from the legislative data that represents activity associated with the legislative issue during a legislative session.

### CROSS REFERENCE TO RELATED APPLICATION

This Application claims the benefit of U.S. Provisional Application Ser. No. 61/491,382 entitled “Legislative Tracker” filed on May 31, 2011, by Brinton Payne, commonly assigned with the present disclosure and incorporated herein by reference in its entirety.

### TECHNICAL FIELD

This application is directed, in general, to representing legislative issues and, more specifically, to providing a mechanism to objectively view legislative issues.

### BACKGROUND

Often presentation of a bill before legislative bodies is long, verbose and cumbersome. Additionally, following the bill through the various steps towards issuance can be a tedious task. This is multiplied when attempting to follow multiple bills through the legislative process of becoming laws. For example, in the 111^{th} Congress of the United States, there were approximately 10,621 bills introduced, wherein only 202 became laws.

In addition to the number of bills, there are several other problems that add to the difficulty of following the progress of bills. For example, physical and cognitive distances can keep entities from getting involved in legislative processes in the capitols and epicenters where bills are legislated. Though lobbyist are an option to follow various bills, financial restraints and complex relationships can keep entities from hiring and managing lobbyists and government affairs personnel.

For those who do have a team of lobbyists, both in house and ‘hired guns,’ it is often difficult to monitor day-to-day activities via phone, e-mail, and existing legislative reporting software communication technologies. However, government reporting or data tracking products, along with news sites, often over analyze or ‘spin’ an issue. Additionally, these reporting products typically provide tracking of legislation in a lengthy verbose manner (i.e., time consuming), charge costly retainers dependent on human interaction, and provide too many bells and whistles for what the average user desires. As such, communication of legislative issues can be lacking and ultimately result in unwarranted legislative action.

### SUMMARY

One aspect provides an apparatus. In one embodiment, the apparatus includes: (1) a data interface configured to receive legislative data associated with a legislative issue and (2) a computer processor configured to generate a progress marker from the legislative data that represents activity associated with the legislative issue during a legislative session.

In another aspect, a method of representing status of a legislative matter is disclosed. In one embodiment, the method includes: (1) receiving legislative data associated with a legislative issue, (2) determining, from the legislative data, a status of the legislative issue with respect to an event of a legislative process during a legislative session and (3) generating a progress marker based on the status that represents activity of the legislative issue during the legislative session.

In yet another embodiment, a legislative tracker is disclosed. In one embodiment, the legislative tracker includes: (1) an interface configured to receive legislative data associated with a legislative issue, (2) an event monitor configured to determine, from the legislative data, a status of the legislative issue with respect to an event of a legislative process during a legislative session, (3) a progress assignor configured to generate a progress marker based on the status that represents activity of the legislative issue during the legislative session and (4) a processor.

### BRIEF DESCRIPTION

Reference is now made to the following descriptions taken in conjunction with the accompanying drawings, in which:

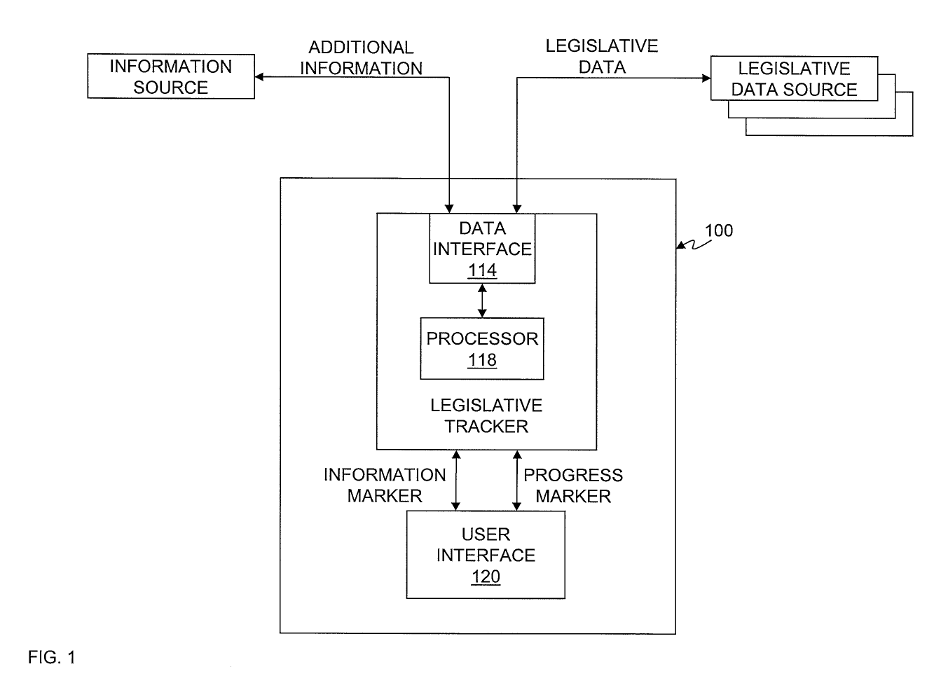

FIG. 1 illustrates a diagram of an embodiment of a legislative tracking system constructed according to the principles of the disclosure;

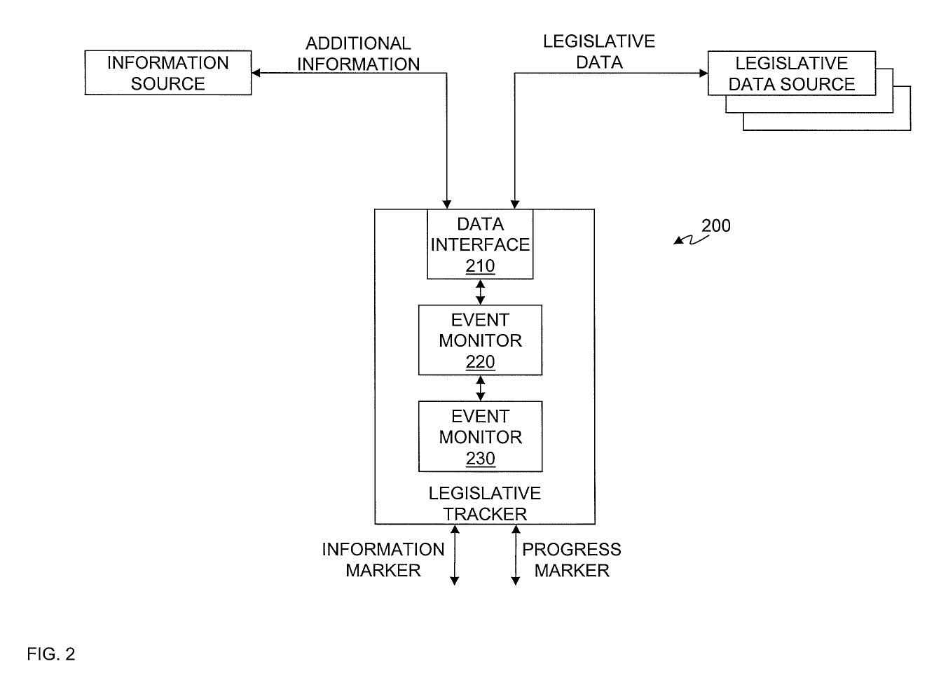

FIG. 2 illustrates a block diagram of an embodiment of an apparatus constructed according to the principles of the disclosure;

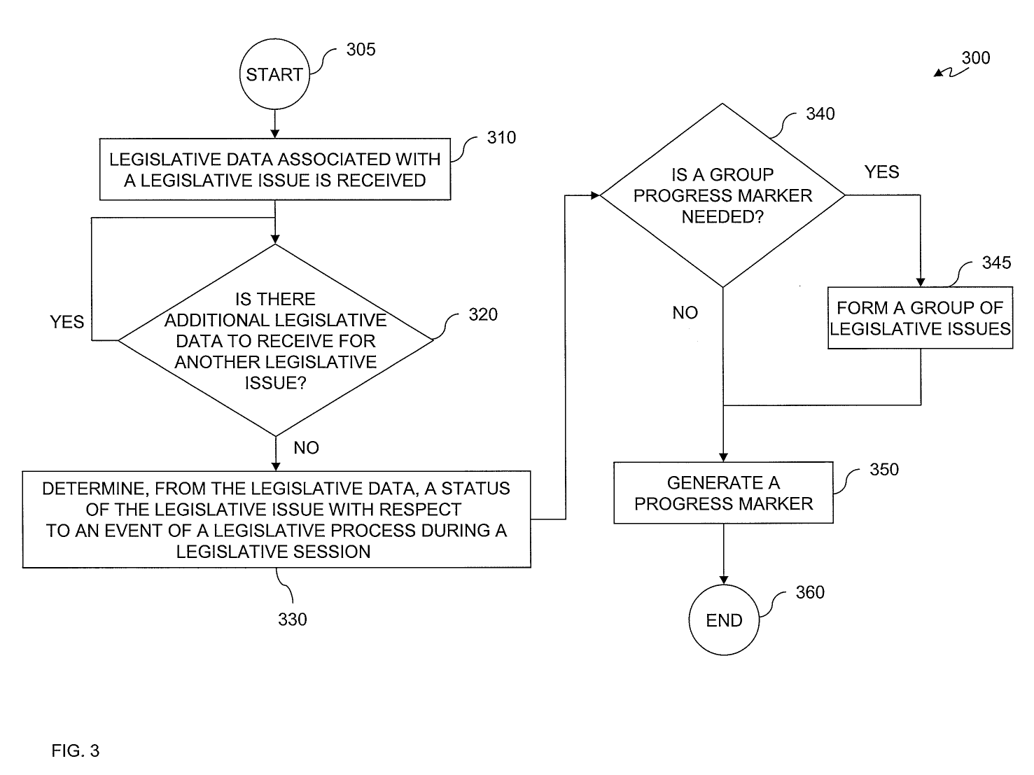

FIG. 3 illustrates a flow diagram of an embodiment of a method of tracking legislative issues carried out according to the principles of the disclosure; and

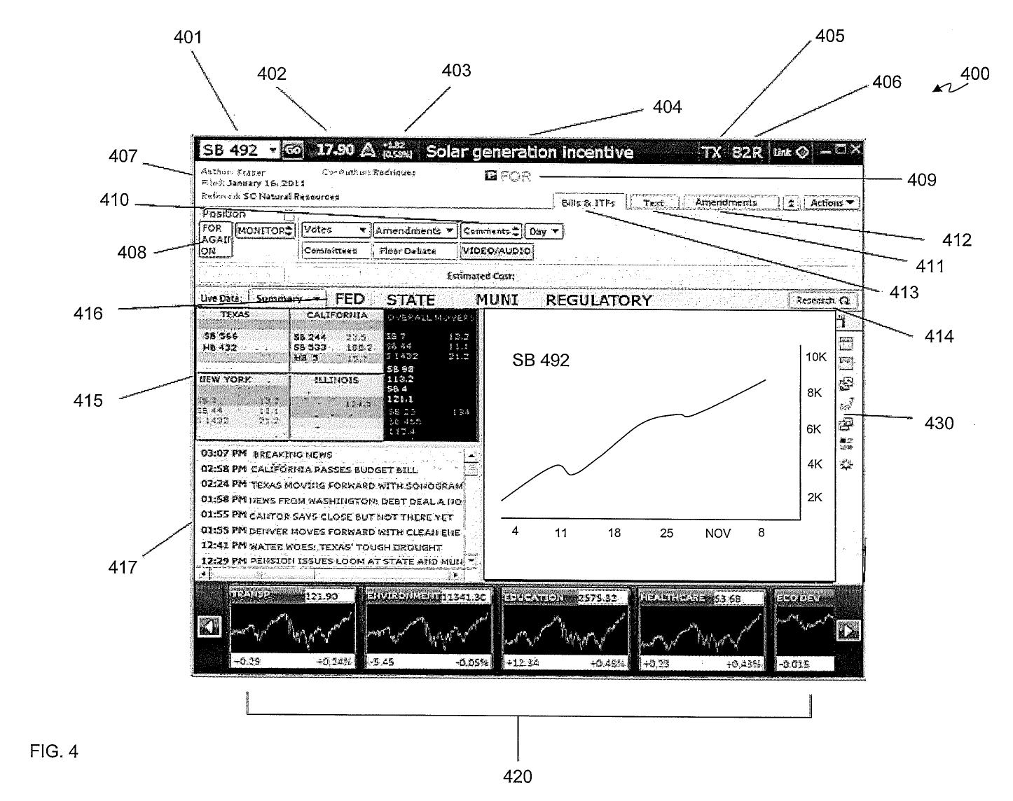

FIG. 4 illustrates a screen shot of one embodiment of a visual representation of progress markers provided according to the principles of the disclosure.

### DETAILED DESCRIPTION

Disclosed herein are embodiments of an invention that provide a dynamic measurement of a legislative issue, or legislative issues, as it moves through the legislative process. The dynamic measurement is generated from legislative data that is obtained from legislative data sources. In one embodiment, the legislative data is obtained in real-time as available. Thus, real-time legislative data reflects progress of a legislative issue as it occurs. In contrast to real-time, reflective data is reported with the benefit of hindsight, e.g., after the legislative issue has expired by, for example, becoming a law, being defeated, being vetoed, etc., or after the occurrence of additional events (i.e., legislative steps) in the legislative process.

A legislative issue is a piece of legislation or a regulatory action of a legislative session. For example, a bill that has been filed with a state legislature. In some embodiments, a legislative issue may be a potential legislative issue that is under development but has not been officially presented or filed with a legislative organization.

FIG. 1 illustrates a diagram of an embodiment of a legislative tracking system 100 constructed according to the principles of the disclosure. The legislative tracking system 100 includes a legislative tracker 110 and a user interface 120. The legislative tracker 110 and the user interface 120 may be located proximate each other or spatially separated, such as via a communications network. The spatial separation can be remote through a communications network or close such as via a local wireless or wired network.

The legislative tracker 110 includes a data interface 114 and a processor 118. To perform the described functions, the legislative tracker 110 may be embodied as a series of operating instruction stored on a non-transitory computer-readable medium that directs the operation of a processor when initiated thereby. In one embodiment, the legislative tracker 110 may be a dedicated computing device including the necessary circuitry (including a processor and memory) or software to perform the described functions.

The legislative tracker 110 is configured to receive legislative data associated with a legislative issue and generate a progress marker from the legislative data that represents activity associated with the legislative issue during a legislative session. The legislative data is received from one or multiple legislative data sources. Each legislative data source that is employed corresponds to the legislative organization associated with the legislative issue. For example, if the legislative issue is a bill in the U.S. House of Representatives, a legislative data source would be an entity that reports on activity within the U.S. House of Representatives. Thomas.gov, opencongress.org, and capitol.state.tx.us are examples of sources for types of legislative data. Accordingly, the legislative data sources can vary based on if the legislative issue is before a legislative organization that is municipal, state, federal, etc. A legislative organization, body or agency is a government entity that generates laws and/or regulations. A single legislative data source, 150 is denoted in FIG. 1 and referred to herein as a representative legislative data source.

The legislative tracker 110 is also configured to receive additional information from an information source or sources. The additional information is non-legislative data that relates to the type of legislative issue that is being tracked. For example, if the legislative issue is a bill directed to operation of rail roads, the additional information may be news reports, financial data, technology reports, etc., corresponding to rail roads. Based on this additional information, the legislative tracker 110 is configured to generate an information marker for the legislative issue. The information marker provides a status or “temperature” of surrounding events, issues, etc. that may affect the progress of the legislative issue. For example, the information marker may be a numeric value that reflects negative news reports about passage of the legislative issue. In some embodiments, the information marker employs symbols (e.g., ++++), a word or words (e.g., good, likely to pass, trouble, etc.), color (e.g., red, yellow, green, etc.), other visual indications or a combination thereof to provide the status. The data interface 114 is configured to receive the additional information and the legislative data.

The legislative tracker 110 is configured to generate a progress marker from the legislative data that represents activity associated with the legislative issue during a legislative session. The progress marker, therefore, is a dynamic measurement of the progress of the legislative issue during a legislative session. The progress marker can reflect both positive and negative progress. The processor 118 is configured to generate the progress marker and the information marker.

The user interface 120 is configured to receive the progress marker from the legislative tracker 110 and provide a visual representation of the progress marker. The user interface 120 may be a conventional display or conventional device having a display that visually represents the progress marker. In one embodiment, the user interface 120 provides multiple progress markers of a legislative issue in a graph format. As such, a user can see the up-to-date progress of a legislative issue within a legislative session. FIG. 4 illustrates a screen shot of one embodiment of a visual representation provided by a user interface according to the principles of the disclosure.

The user interface 120 is also configured to receive the information marker and provide a visual representation thereof. The information marker may represent subjective data associated with a legislative issue. Accordingly, a person, user, viewer, etc., of the user interface 120 can review objective data of a legislative issue provided from the progress marker or markers and the subjective data provided from various reporting resources.

FIG. 2 illustrates a block diagram of an embodiment of a legislative tracker 200 constructed according to the principles of the disclosure. The legislative tracker 200 includes a data interface 210, an event monitor 220 and a progress assignor 230. In one embodiment, at least a portion of the legislative tracker 200 is embodied as a series of operating instruction stored on a non-transitory computer-readable medium that directs the operation of a processor when initiated thereby. For example, the progress assignor 230 may be embodied as operating instructions, stored on a non-transitory computer readable medium, that correspond to an algorithm or algorithms that determine progress and assign status values. In some embodiments, at least a portion of the legislative tracker 200 may be a dedicated computing device including the necessary circuitry (including a processor and memory) or software to perform the described functions.

The data interface 210 is configured to receive legislative data associated with a legislative issue. The data interface 210 may be a conventional interface that receives and transmits data according to conventional communication standards. Various formats may be employed for the legislative data including XML, CSV, HTTP and POST. In some embodiments, the data interface 210 is configured to receive the legislative data in a predetermined format. In other embodiments, the legislative tracker 200 is configured to determine the format of the legislative data, such as upon receipt, and process accordingly.

In one embodiment, the legislative data is received in response to a request generated by the event monitor 220. The request may be generated automatically or manually upon initiation from a user. Automatic requests may be generated regularly, such as every night or each night of an applicable legislative session. The requests may also be generated when initiated by a manager, director, owner, etc., of the legislative tracker 200. In some embodiments, the request is generated and the legislative data obtained according to the operating procedures of the legislative data source. For example, if a legislative data source nightly processes data and then provides it for viewing or distribution, then the request is generated according to when the legislative data is ready to be obtained.

The event monitor 220 is configured to determine, from the legislative data, or an aggregation thereof, a status of the legislative issue with respect to an event of a legislative process during a legislative session. The event monitor 220 can be configured to parse the received legislative data and extract the status of the legislative issue with respect to a step within the legislative process. In one embodiment the event monitor 220 is configured to perform a word search and determine the status based on words that are found or not found. For example, a search for the text string “assigned to committee” can be performed to determine a status. A numeric value can then be assigned if found or not found.

The progress assignor 230 is configured to generate a progress marker based on the status that represents activity of the legislative issue during the legislative session. The activity indicates progress within the legislative process for the legislative issue to become a law during the legislative session. In one embodiment, the progress marker 230 is configured to generate the progress marker based on a numeric value associated with the status of a step in the legislative process. For example, the progress marker 230 may assign a predetermined numeric value as the progress marker based on the determined status for a step. Status values can be listed in an XML report for various steps of a legislative process during a legislative session. The status values can be used to determine the progress of a legislative issue. In one embodiment, the status values are predetermined and correspond to various steps of a legislative issue as follows.
0=“Unfiled”
1=“Filed”
1000=“Prefiled”
2000=“Introduced/1st reading”
10000=“Assigned to committee (1st chamber)”
11000=“Assigned to committee”
13000=“Died/tabled in committee”
15000=“Assigned to subcommittee”
20000=“Hearing scheduled”
30000=“Passed by 1st committee”
35000=“Passed by at least 2 committees”
45000=“Floor vote scheduled (first chamber)”
46000=“Died/tabled/withdrawn from floor (1st chamber)”
50000=“Passed first house”
55000=“Assigned to committee (second chamber)”
60000=“Passed committee in second chamber”
65000=“2nd chamber floor vote scheduled”
66000=“Died/tabled/withdrawn from floor (2nd chamber)”
70000=“Passed second chamber”
72000=“In conference or conference pending”
73000=“Died in conference”
74000=“Passed legislature”
74999=“Passed legislature”
75000=“Enrolled”
75999=“Enrolled”
76000=“Transmitted to governor”
76999=“Transmitted to governor”
80000=“Vetoed or sent back to legislature with amendments.”
80999=“Vetoed or sent back to legislature with amendments”
81000=“Indication of “friendly” veto or governor's amendments. (not all states support)”
81999=“Indication of “friendly” veto or governor's amendments.”
82000=“Veto sustained by vote of at least one chamber”
82999=“Veto sustained by vote of at least one chamber”
94000=“Governor's amendments accepted by legislature”
94999=“Governor's amendments accepted by legislature”
95000=“Signed by governor”
95999=“Signed by governor”
96000=“Final adoption. Signed by governor or veto overridden or no signature needed”
96999=“Final adoption. Signed by governor or veto override”
99000=“Enacted or chaptered”
99999=“Enacted or chaptered”

In this example, the values for the various steps increase over time as the legislative issue moves through the legislative process during a legislative session. In some embodiments, the values are added together to generate the progress marker. As such, the progress marker is a cumulative value. For example, instead of generating the progress marker by assigning a single status value as in the above example, multiple status values are added together to generate the progress marker. Thus, a first progress marker could be 100 for a legislative issue being filed. Subsequently, the progress marker is updated to 300 as a result of the legislative issue being prefiled (i.e., 100 for being filed and 200 for being prefiled for a total of 300).

The progress marker is a dynamic marker that changes based on the activity associated with the legislative issue. The progress assignor 230 is configured to generate the progress marker based on parameters corresponding to the legislative process. In one embodiment, the parameters include time of the legislative session, steps within a legislative process, components of the legislative issue, support for the legislative issue, and amendments to the legislative issue.

In one embodiment the progress assignor 230 employs an algorithm to generate the progress marker. The algorithm can take the steps of the legislative process and compare them against the time (presumably remaining) to the end of a legislative session. For example, the Texas Legislature has a session of 140 days. If a legislative issue moves in the last days of a session, the status value for it is a higher ‘raw score’ than if the legislative issue moves early in the legislative session. But as each day passes, the value of the progress marker for the legislative issue goes down.

In one embodiment, the legislative tracker 200 is configured to track multiple legislative issues at once. As such, the data interface 210 is configured to receive legislative data associated with multiple legislative issues. In some embodiments, the legislative tracker 200 is configured to generate a group progress marker for a group of related legislative issues. As such, the progress assignor 230 is configured to create a group of at least two of the related legislative issues. The progress assignor 230 may group legislative issues by performing a word search of the title, body, abstract, etc., of a legislative issue and group the legislative issues based on matching or similar words or subject matter. In some embodiments, the progress assignor 230 may receive input from a user, manager, or client of the legislative tracker 200 that indicates which legislative issues to group together. In some embodiments, the legislative issues that are grouped together may be from different legislative bodies. For example, there may be a first oil and gas bill before a state legislative body and a second oil and gas bill before a city legislative body. The progress assignor 230 can be configured to combine the first and second bills together in a group and generate a group progress marker based on the individual activity of both of the bills.

The progress assignor 230 is also configured to generate an information marker for a legislative issue or issues based on additional information associated with the topic of the legislative issue or issues.

FIG. 3 illustrates a flow diagram of an embodiment of a method of tracking legislative issues carried out according to the principles of the disclosure. At least a portion of the method 300 can be performed by a legislative tracker as disclosed herein. A computing device may include the necessary logic circuitry to carry out the method 300. In one embodiment, the method 300 may be embodied as a series of operating instructions that are stored on a non-transitory computer readable medium and used to direct the operation of a processor when initiated thereby. The method 300 begins in a step 305.

In a step 310, legislative data associated with a legislative issue is received. The legislative data may be received from a single legislative data source or from multiple legislative data sources. The legislative data may be received without prompting or in response to a command sent by, for example, a legislative tracker as disclosed herein. Conventional communication procedures and networks can be used to receive the legislative data. Additionally, the legislative data can be communicated in conventional formats. In one embodiment, the legislative data is received in a format selected from the list including XML, CSV, HTTP and POST.

In a first decisional step 320, a determination is made if there is additional legislative data to receive for another legislative issue. If so, the method 300 continues to step 310 and receives additional legislative data and/or information data. In one embodiment, legislative data from legislative sources associated with different legislative bodies is received. For example, one legislative issue may be a bill in front of the U.S. House of Representatives and another legislative issue is a bill in front of a state House of Representatives. If there is no additional legislative issue upon which data is to be received at this time, the method 300 continues to step 330.

In the step 330, a status of the legislative issue with respect to an event of a legislative process during a legislative session is determined from the legislative data in a step 320. In one embodiment, the event or events correspond to a step or steps of the legislative process wherein the legislative issue becomes a law.

In a second decisional step 340, a determination is made if a group progress marker is needed. If not, the method 300 proceeds to step 350. If yes, the method 300 continues to step 345 wherein at least two legislative issues are combined to form a group of legislative issues. The method then proceeds to step 350.

In the step 350, a progress marker is generated based on the status that represents activity of a legislative issue during the legislative session. If a group has been formed in step 345, the generated progress marker is a group progress marker.

The activity indicates progress within the legislative process for the legislative issue to become a law during the legislative session. In one embodiment, generating the progress marker includes employing a predetermined numeric value corresponding to the status as the progress marker. In some embodiments, generating the progress marker is based on designated parameters that have been selected by, for example, a user, manager, client, of a legislative tracker, to represent the activity of the legislative issue. In one embodiment, the parameters include at least one of the following parameters: time of said legislative session, steps within a legislative process, components of said legislative issue, support for said legislative issue, and amendments to said legislative issue.

In a step 360, the method 300 ends. In one embodiment, multiple progress markers are generated in real time for a legislative issue or a group of legislative issues during a legislative session. The multiple progress markers are provided to a display device, such as a computer screen, to allow a viewer to see the progress of a legislative issue during a legislative session. FIG. 4 provides an example of a view for displaying multiple progress markers for a legislative issue.

In addition to receiving the legislative data, associated information data can be received from a single information source or multiple information sources. The information data may be received without prompting or in response to a command sent by, for example, a legislative tracker as disclosed herein. Conventional communication procedures and networks can be used to receive the information data. From the information data, an information marker or markers can be generated and provided to a user with the progress marker.

FIG. 4 illustrates a screen shot of one embodiment of a visual representation 400 of progress markers for a legislative issue that is provided according to the principles of the disclosure. The particular legislative issue in FIG. 4 is Senate Bill 492 from Texas. As such, instead of legislative issue, the bill number will be referred to in the following discussion of FIG. 4. In addition to the progress markers, other data associated with Senate Bill 492 is provided for viewing. Some of this additional data that is presented is discussed below.

The visual representation 400 includes an identification section 401 that is configured to indicate the legislative issue represented. Typically, this is a numeric or an alpha-numeric value. The identification section 401 allows user input via a user interface, such as a keyboard, keypad, microphone, etc., wherein a search can be conducted for a particular legislative issue. The “GO” button initiates a search for a particular legislative issue that has been entered. The search can be by number, keyword (such as from the title or abstract), state, or a combination thereof. The down arrow indicates a drop down list wherein a particular legislative issue can be selected.

A current value section 402 indicates the existing value of the progress marker. Typically, the existing value is a daily value that corresponds to when legislative data is received. A trend section 403 is also provided that shows the difference between the existing value of the progress marker compared to the previous reported progress marker. This can be from the day before. The trend section 403 allows a user to quickly view the movement, either up or down, of the legislative issue.

Subject section 404 illustrates a brief description of the legislative issue. In one embodiment, the description is automatically extracted from a caption of the legislative issue. In some embodiments, the description can be manually entered or edited after being extracted. The origin section 405 shows the place of origin for the legislative issue. For SB 492, the origin is the state of Texas. The session section 406 indicates the particular section upon which the legislative issue is considered. The origination section 407 includes the author, co-author(s), filing date, committee, or other additional data that indicates the origin of the legislative issue.

The visual representation 400 also includes sections and tabs that allow a user to pick a position on the legislative issue, add comments, view text of the legislative issue and view text of amendments. Additional buttons are also provided that allow a user to obtain more information about the legislative issue and connect to audio/video corresponding to the legislative issue (e.g., debates, presentations, etc., that are either live or recorded). In particular, a selector 408 is provided that allows a user to pick a position on the legislative issue. A position display 409 illustrates the current position selection. A comment button 410, a text tab 411 and an amendment tab 412 are also noted on the visual representation 400. A “Bills and ITF's” tab 413 is the present tab that is illustrated, which includes the progress markers for the selected bill, SB 492, and associated Issue Traded Funds. A research button 414 is configured to provide research that has been done for the legislative issue when selected. The research can reflect studies that have been performed specifically for the legislative issue or associated with a topic of the legislative issue.

Additional buttons and/or tabs are also provided to allow a user to remain up-to-date on other legislative issues. A user can select federal, state, municipal or regulatory issues to track. The status of the legislative issues that correspond to a user's selection are provided in the snapshot section 415. The snapshot section 415 provides the biggest movers (i.e., greatest status change) from the selected type of legislative entities. The entity buttons 416 allow a user to determine what is viewed in the snapshot section 415.

A news section 417 is configured to provide news and press releases of different legislative issues. The news and press releases can cover multiple topics.

Economic section 420 is configured to provide a view of the status of various funds. The funds may be selected to correspond to the topic of the legislative issue that is displayed. The selection may be automatically performed by a legislative tracker as described herein or may be manually selected by a user.

The visual representation 400 also includes the activity section 430 that illustrates a graphical view of the multiple progress markers 435 in the form of a continuous line. As such, a user can see the progress of the selected legislative issue, SB 492 over time (i.e., a legislative session). The horizontal axis is a time axis that illustrates days of a month. The vertical axis is a value axis that illustrates the status value of the progress markers. The range of the values is selected based on the scale of status values that are employed. Here 10,000 is used to correspond to the above example.

The above-described apparatuses and methods may be embodied in or performed by various conventional digital data processors or computers, wherein the computers are programmed or store executable programs of sequences of software instructions to perform one or more of the steps of the methods, e.g., steps of the method of FIG. 3. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, e.g., one or more of the steps of the method of FIG. 3. A non-transitory computer readable media as employed herein indicates that the claimed invention is not embodied as a mere signal or wave. Additionally, an apparatus, such as a dedicated computing device, may be designed to include the necessary circuitry to perform each step of the methods disclosed herein including the method of FIG. 3.

Those skilled in the art to which this application relates will appreciate that other and further additions, deletions, substitutions and modifications may be made to the described embodiments. Additionally, the hairstylists and clients referred to in this application are not restricted to professional hairstylists and paying clients.

What is claimed is:

1. An apparatus, comprising:
a data interface configured to receive legislative data associated with a legislative issue; and
a computer processor configured to generate a progress marker from said legislative data that represents activity associated with said legislative issue during a legislative session.

2. The apparatus as recited in claim 1 wherein said legislative issue is a bill or a proposed regulatory action.

3. The apparatus as recited in claim 1 wherein said activity indicates progress within a legislative process for said legislative issue to become a law during said legislative session.

4. The apparatus as recited in claim 1 wherein said progress marker is dynamic.

5. The apparatus as recited in claim 1 wherein said processor is configured to generate said progress marker based on parameters selected from the group consisting of:
time of said legislative session,
steps within a legislative process,
components of said legislative issue,
support for said legislative issue,
support against said legislative issue, and
amendments to said legislative issue.

6. The apparatus as recited in claim 1 wherein said interface is further configured to receive legislative data for multiple legislative issues and said processor is further configured to create a group of at least two of said multiple legislative issues and generate a group progress marker for said group.

7. The apparatus as recited in claim 1 wherein said processor is configured to generate said progress marker based on numeric values assigned to steps of said legislative process.

8. A method of representing status of a legislative matter, comprising:
receiving legislative data associated with a legislative issue;
determining, from said legislative data, a status of said legislative issue with respect to an event of a legislative process during a legislative session; and
generating a progress marker based on said status that represents activity of said legislative issue during said legislative session.

9. The method as recited in claim 8 wherein said generating includes employing a predetermined numeric value corresponding to said status as said progress marker.

10. The method as recited in claim 8 wherein said legislative issue is a bill or a proposed regulatory action.

11. The method as recited in claim 8 wherein said activity indicates progress within said legislative process for said legislative issue to become a law during said legislative session.

12. The method as recited in claim 8 wherein said progress marker is dynamic.

13. The method as recited in claim 8 generating said progress marker is based on parameters selected from the group consisting of:
time of said legislative session,
steps within a legislative process,
components of said legislative issue,
support for said legislative issue, and
amendments to said legislative issue.

14. The method as recited in claim 8 further comprising receiving legislative data for multiple legislative issues, creating a group of at least two of said multiple legislative issues and generating a group progress marker for said group.

15. A legislature tracker, comprising:
an interface configured to receive legislative data associated with a legislative issue;
an event monitor configured to determine, from said legislative data, a status of said legislative issue with respect to an event of a legislative process during a legislative session;
a progress assignor configured to generate a progress marker based on said status that represents activity of said legislative issue during said legislative session; and
a processor.

16. The legislative tracker as recited in claim 16 wherein said generating includes employing a predetermined numeric value associated with a status of said legislative issue.

17. The legislative tracker as recited in claim 16 wherein said legislative issue is a bill or a proposed regulatory action and said activity indicates progress within said legislative process for said bill or said proposed regulatory action to become a law during said legislative session.

18. The legislative tracker as recited in claim 16 generating said progress marker is based on parameters selected from the group consisting of:
time of said legislative session,
steps within a legislative process,
components of said legislative issue,
support for said legislative issue, and
amendments to said legislative issue.

19. The legislative tracker as recited in claim 16 further comprising receiving legislative data for multiple legislative issues, creating a group of at least two of said multiple legislative issues and generating a group progress marker for said group.

20. The legislative tracker as recited in claim 16 further comprising generating an information marker for said legislative issue based on additional information associated with a topic of said legislative issue.
